(19) United States
(12) Patent Application Publication
(10) Pub. No.: US 2021/0123459 A1
(43) Pub. Date: Apr. 29, 2021

(54) On/Off Hydraulic Valve

(71) Applicant: Aalto University Foundation sr, Aalto (FI)

(72) Inventor: Tapio LANTELA, Espoo (FI)

(73) Assignee: Aalto University Foundation sr, Aalto (FI)

(21) Appl. No.: 17/057,136

(22) PCT Filed: May 15, 2019
(86) PCT No.: PCT/FI2019/050382

§ 371 Date: Nov. 20, 2020

(30) Foreign Application Priority Data
May 21, 2018 (FI) 20180070
Jan. 28, 2019 (FI) 20195050

(51) Int. Cl. F15B 11/042; F15B 13/04; F15B 13/043; F15B 13/08; F16K 31/06; F16K 31/42

(52) U.S. Cl. CPC F15B 11/0426; F15B 13/0405; F15B 13/0431; F15B 13/0817; F15B 2211/40592; F15B 13/0842; F16K 31/0631; F16K 31/423; F15B 13/0839

(57) ABSTRACT

A hydraulic valve includes an on/off seat-type main valve with two ports having a displaceable poppet for opening and closing the main flow channel; an on/off seat-type pilot valve with three ports, with a magnetomotive force producing coil, a magnetic circuit, and an anchor movable with the magnetomotive force produced by the coil; and a frame with required channels and spaces for the poppet and for the anchor. Closing the inlet channel displaces the poppet and opens the main flow channel. Opening the inlet channel forces the poppet to close the main channel. The anchor includes a frame with a first sealing element for closing the low-pressure outlet channel of the pilot valve and with a second sealing element for securing the closing of the high-pressure inlet channel of the pilot valve. The sealing surface of the second sealing element is movable in relation to the frame of the anchor.

The present invention relates to hydraulic pilot-operated seat type on/off valves.

Actuators in hydraulic systems are typically controlled with spool type proportional valves, where with one spool one or more flow paths i.e. metering edges can be controlled. Spool type proportional valves allow controlling the flow rate of hydraulic fluid in proportion to the position of the spool. Spool type proportional valves, however, have some weaknesses, such as constant leakage caused by clearance around the spool, which reduces the energy-efficiency of proportional valve-controlled systems. In order to reduce this leakage, the clearance is made very small, which requires high machining accuracy and increases the cost of manufacturing spool type valves. The small clearance also makes spool type valves sensitive to contaminants in the hydraulic fluid, which results in high fluid filtering requirements.

Hydraulic spool or seat type on/off valves can be utilized to close or open one flow path. They do not generally enable controlling the velocity of an actuator but they enable blocking fluid flow and thus the movement of an actuator or changing the direction of fluid flow and thus the direction of actuator movement. Commonly, main control functions of hydraulic systems are realized with proportional valves and in addition a relatively small number of on/off valves are utilized in for example safety functions.

In an on/off seat type valve, the main flow path is opened by moving a poppet away from an orifice and the flow path is closed when the poppet is in contact with the orifice's seat surface. The contact between the poppet and the seat enables practically leak-free closing of the flow path. The structure of seat type on/off valves is also relatively simple and does not require as small clearances or as precise machining as used in spool type proportional valves. The smaller clearances make seat type valves less sensitive to jamming caused by particle contamination and temperature changes in hydraulic fluid, in comparison to spool-type valves, for example. Therefore, utilizing seat type on/off valves instead of proportional valves to control hydraulic actuators can reduce fluid filtering requirements and improve reliability and energy efficiency of hydraulic systems.

In parallel on/off hydraulic valve systems, also called digital valve systems, a plurality of hydraulic on/off valves are connected in parallel, to create a flow control device called Digital Flow Control Unit (DFCU). In this kind of flow control devices, the desired flow rate is created by opening a suitable subset of valves, thus enabling a similar functionality as in one metering edge of a proportional spool type valve. Several digital flow control units can be combined to create an on/off valve system with, for example, four metering edges and a similar functionality as a commonly used spool type 4/3 proportional valve has. In a DFCU, the individual on/off valves can be smaller than a spool type valve with a flow capacity comparable to the flow capacity of the whole DFCU. The small size of the on/off valves can enable the DFCU to have a much faster response than a comparable spool type valve. The metering edges in a digital valve system are also independently controllable, as opposed to metering edges in the commonly used proportional valves. Due to parallel connected valves, the DFCUs can operate with reduced performance even when one or several on/off valves in them are faulty, which makes the DFCU fault-tolerant. Therefore, controlling hydraulic actuators with parallel on/off valve systems instead of proportional valves can improve reliability, energy efficiency and also performance of hydraulic systems.

Another example of a device which requires a plurality of hydraulic on/off valves is a hydraulic multi-pressure actuator. In a hydraulic multi-pressure actuator some of a plurality of pressure sources with different pressure levels are connected to a hydraulic actuator in order to realize a desired output force. In this application, the on/off valve system consists of a plurality of metering edges, each of which commonly contains only one on/off valve.

Further example of an application which requires a plurality of hydraulic on/off valves is controlling of a hydraulic multi-chamber cylinder, wherein pressure from a single pressure source is controllably divided to a plurality of chambers in the cylinder with the hydraulic on/off valves.

The present-day hydraulic valve systems, including the valve systems where metering edges are formed by DFCUs and the valve systems which contain a plurality of metering edges with a single on/off valve in each, are generally formed from commercially available on/off hydraulic valves. These valves are relatively large-sized and have modest dynamics, making the valve systems also much larger (bulky) and slower when compared to proportional valves with corresponding flow capacity.

Thus, there is a need for a small sized hydraulic on/off valve, especially as a part of a larger unit comprising a plurality of such valves.

The present invention provides a pilot-operated seat type on/off valve, which may be designed to be a part of a larger unit comprising a plurality of the valves. The valves of the present invention may preferably be mainly formed from shapes manufactured in the frame parts of such a larger unit. This way separate valves require only of few individual parts, which significantly simplifies the manufacture of larger valve units comprising even several tens of valves, and allows for a very small size for the unit.

The hydraulic valves of the invention also allow very fast response, which together with a separate edge control of a flow control unit allow for a very precise control of the hydraulic actuator. Further, the present invention provides a hydraulic on/off valve which in de-energized state can block the flow regardless of the direction of the pressure difference over the valve.

The hydraulic valve of the invention comprises:
an on/off seat-type main valve with two ports comprising a displaceable poppet for opening and closing the main flow channel,
an on/off seat-type pilot valve with three ports, which comprises a magnetomotive force producing coil, a magnetic circuit, and an anchor movable with the magnetomotive force produced by the coil,
and a frame with required channels and spaces for the poppet of the main valve and for the anchor of the pilot valve,
wherein the anchor of the pilot valve comprises a frame with a first sealing element for closing the low-pressure outlet channel of the pilot valve and with a second sealing element for securing the closing of the high-pressure inlet channel of the pilot valve, wherein the sealing surface of the second sealing element is movable in relation to the frame of the anchor of the pilot valve,
wherein closing of the inlet channel of the pilot valve allows displacement of the poppet of the main valve for opening the main flow channel of the main valve,
and wherein opening of the inlet channel of the pilot valve forces the poppet of the main valve to close the main channel of the main valve.

With the movable sealing surface of the second sealing element of the anchor of the pilot valve the closing of the high-pressure inlet channel can be guaranteed regardless of wear of the sealing surfaces and impurities in the hydraulic liquid, etc., while simultaneously ensuring a gapless closure of the magnetic circuit when the armature is pulled upwards by the magnetic force. The sealing surface of the second sealing element is the surface which, when in contact with the edges of the orifice of the inlet channel of the pilot valve, blocks the flow through the inlet channel of the pilot valve.

The sealing elements of the anchor of the pilot valve can be formed as integral parts of the frame of the anchor, or the sealing members may be separate parts connected to the frame of the anchor.

In an embodiment of the hydraulic valve of the invention the sealing surface of the second sealing element of the anchor of the pilot valve extends at least partially outwards from the frame of the anchor. In this embodiment the frame of the anchor of the pilot valve preferably comprises a surface towards the high-pressure inlet, from which surface the sealing surface of the second sealing element extends outwards. The surface of the anchor of the pilot valve towards the high-pressure inlet from which the sealing surface of the second sealing element extends outwards may be a substantially level surface or substantially a conical surface, for example.

In an embodiment of the hydraulic valve of the invention the sealing surface of the second sealing element is supported with a spring force in relation to the frame of the anchor of the pilot valve. This spring force may be achieved with a spring, with a helical spring or a plate spring for example, utilized in fixing of the second sealing element or its sealing surface to the frame of the anchor of the pilot valve, or obtained by suitable elasticity of the material of the second sealing element or its sealing surface, for example.

In an embodiment of the hydraulic valve of the invention the frame is at least partially manufactured with an additive manufacturing method, preferably by laminated object manufacturing or by selective laser melting.

In an embodiment of the hydraulic valve of the invention the valve is a miniature hydraulic valve, having a small size and a large flow capacity. The “miniature” is definable in this context for example with one or both of the following characteristics: the size of a single valve acting as a part of a larger valve system, i.e. the volume of the electromagnetic actuator and the pilot and main valve structures of a single pilot operated valve, is under 10 cm³ when not taking to account for example the volume of the related main flow channels in the valve system, and the flow capacity of the main valve is over 1 I/min with a pressure difference over the main valve of 5 bar. Further, the pressure level of the hydraulic valve of the invention may be up to 300 bar.

In an embodiment of the hydraulic valve of the invention the frame is formed from two or three separate material layers connected together to form one frame entity. The separate material layers allow easy machining of at least some of the required spaces and channels to and/or via the connecting surfaces of the material layers. This embodiment also allows manufacture of at least some of the layers with suitable additive manufacturing method.

In the above embodiment the one frame entity preferably comprises required spaces and channels for a plurality of hydraulic valves. This allows a plurality of the hydraulic valves to be located inside one single structural entity.

In an embodiment of the hydraulic valve of the invention the poppet of the main valve blocks the flow in the main flow channel in both flow directions.

In an embodiment of the hydraulic valve of the invention the high pressure for the pilot valve is taken from the high pressure side of the main flow channel and the low pressure for the pilot valve is taken from the low pressure side of the main flow channel.

The present invention also provides a valve system which comprises a plurality of the hydraulic valves of the invention. The configuration of the metering edges inside the valve system may vary, i.e. the valve system may consist of one or several DFCUs, where each of the metering edges is controlled by multiple parallel on/off valves, or the valve system may be used to control a plurality of metering edges as required for example by a hydraulic multi-pressure actuator or for controlling a hydraulic multi-chamber cylinder.

More precisely the features defining a hydraulic valve in accordance with the present invention are presented in claim 1. Dependent claims present advantageous features and embodiments of the invention.

Exemplifying embodiments of the invention and their advantages are explained in greater detail below in the sense of example and with reference to accompanying drawings, where

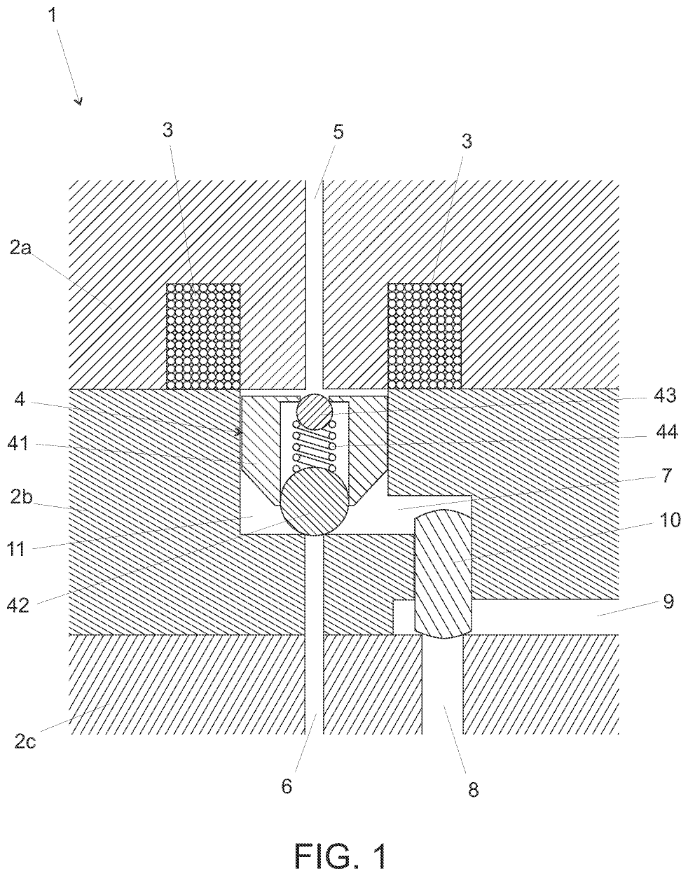

FIG. 1 shows schematically an embodiment of a hydraulic valve of the invention as a cross-sectional view,

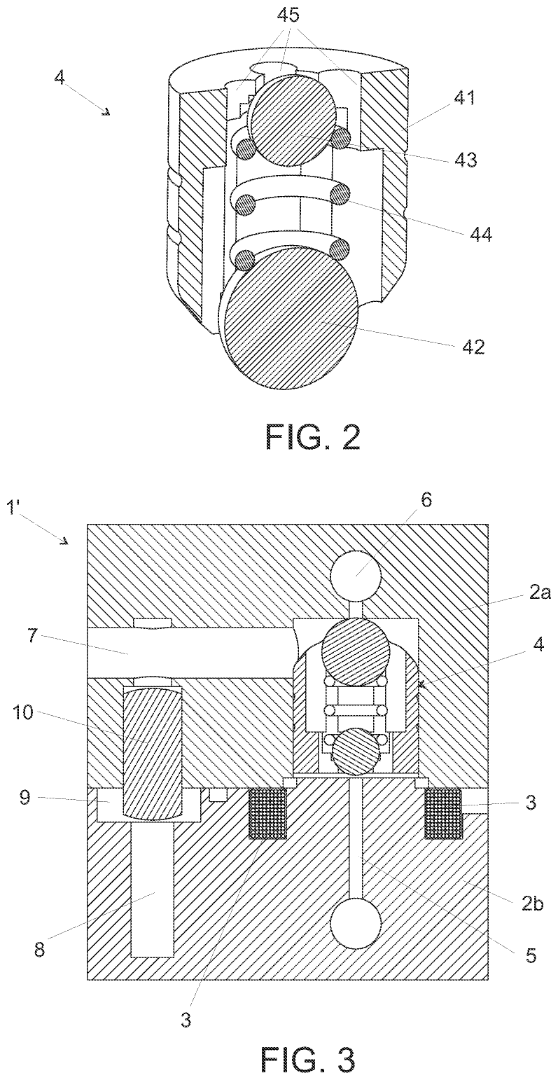

FIG. 2 shows schematically an embodiment of an anchor of the pilot valve of the hydraulic valve of the invention as a cross-sectional perspective view.

FIG. 3 shows schematically an alternative embodiment of a hydraulic valve of the invention as a cross-sectional view,

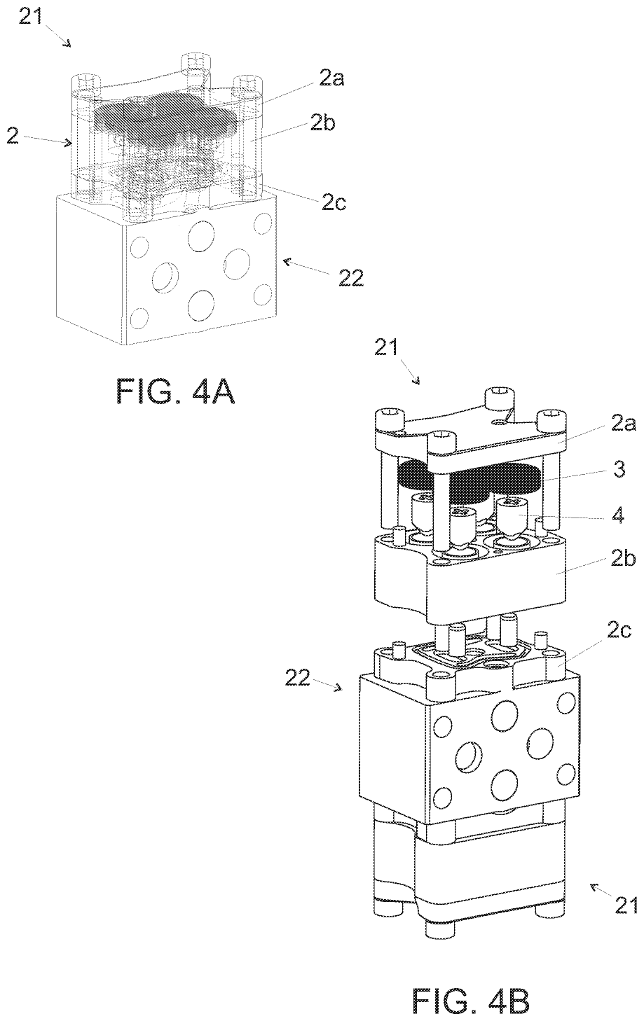

FIGS. 4A and 4B show schematically an embodiment of a valve block comprising a plurality of hydraulic valves of the invention.

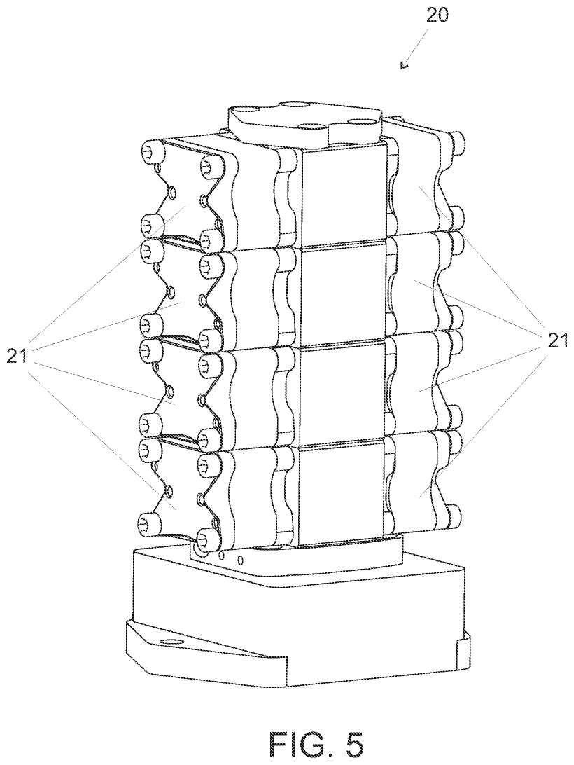

FIG. 5 shows schematically an embodiment of a valve system comprising a plurality of hydraulic valves of the invention.

In FIG. 1 is schematically shown a cross-section of a hydraulic valve 1 of the invention. The hydraulic valve comprises a frame formed from three material layers 2a, 2b and 2c, inside which frame is formed the three main parts of the hydraulic valve: an electromagnetic solenoid actuator, a pilot valve and a main valve.

The electromagnetic solenoid actuator comprises a coil 3, and the frame parts 2a and 2b together with the frame of anchor 4, which form the magnetic circuit of the solenoid actuator. The parts 2a, 2b and 4 of the magnetic circuit are made from magnetically soft material, wherein the frame parts 2a and 2b surrounds the coil 3 and guides the magnetic flux through the frame 41 of the anchor 4.

The pilot valve comprises an anchor 4, a high-pressure inlet channel 5, a low-pressure outlet channel 6, and a pilot control channel 7.

The main valve comprises main flow channels 8 and 9, and a poppet 10.

The anchor 4 of the pilot valve is formed from a frame part 41, to which frame part is fixedly connected a first sealing element 42 for closing the low-pressure outlet channel 6. In this embodiment the sealing element 42 is a ball bearing. The anchor 4 also comprises a second sealing element 43, which is also in this embodiment in form of a metal or ceramic ball and which is located partially inside the frame part 41 and connected to the first sealing element 42 with a spring 44.

The anchor 4 of the pilot valve is located in an anchor space 11 formed in the second frame material layer 2b vertically movably (upwards and downwards in the orientation of the FIG. 1). In the position of FIG. 1 the first sealing element 42 of the anchor closes the low-pressure outlet channel 6 and the high-pressure inlet channel 5 is open, which causes the high-pressure liquid in the pilot control channel 7 to force the poppet 10 of the main valve to keep the main flow channel 8 closed.

For opening the main valve, the coil 3 is energized for creating a magnetomotive force, which pulls the anchor 4 upwards towards and against the surface of the first material layer 2a of the frame. In this position the second sealing element 43 is forced to close the high-pressure inlet channel 5. Proper closing of the opening of the high-pressure channel 5 is guaranteed with the spring force of the spring 44, which allows relative movement of the second sealing element 43 in relation to the frame part 41 of the anchor 4. With the upward movement of the anchor 4, the first sealing element 42 opens the low-pressure outlet channel 6 thus causing the pressure in the pilot control channel 7 to drop. The pressure drop in the pilot control channel 7 allows the hydraulic pressure of the liquid in the main flow channels 8 and 9 to push the poppet 10 upwards thus opening the main valve and connecting the main flow channels 8 and 9, and allowing liquid to flow through the main valve.

For closing the main valve, the coil 3 is de-energized, which causes the magnetomotive force to drop, anchor 4 of the pilot valve is pushed downwards due to the hydraulic pressure in high-pressure inlet channel 5, the first sealing element 42 closes the low-pressure outlet channel 6, and the hydraulic pressure from the high-pressure inlet channel 5 causes the pressure in the pilot control channel 7 to increase, which causes the poppet 10 of the main valve to close the main flow channel 8.

In FIG. 2 is schematically shown an embodiment of a structure of an anchor 4 of the pilot valve for the hydraulic valve of the invention. In addition the parts already shown in FIG. 1, the frame part 41, the first sealing element 42, the second sealing element 43 and the spring 44, this figure illustrates channels 45, which helps the hydraulic pressure from the high-pressure inlet channel 5 (FIG. 1) to pass through the anchor 4 to the pilot control channel 7 (FIG. 1), when the pilot valve is open.

In FIG. 3 is schematically shown an alternative embodiment of a hydraulic valve 1′ of the invention. In this embodiment the valve structure is otherwise substantially same than in FIG. 1, but the frame of the valve is formed from only two frame material layers 2a and 2b, the coil 3 of the solenoid actuator is located below the anchor 4 of the pilot valve, and the structure of the pilot valve is turned to reversed horizontal orientation.

FIGS. 4A and 4B show schematically an embodiment of a valve block 21 comprising a plurality of, in this embodiment four, hydraulic valves of the invention connected to the channeling 22 of a larger valve unit. FIG. 4A shows the valve block 21 in perspective view, and FIG. 4B shows exploded view of the valve block 21 with a second, unexploded valve block 21 connected to the opposite side of the channeling 22.

In the valve block 21 there are four valves in a square formation located inside the valve block. The valve block 21 comprises a single frame 2, which is formed from three material layers 2a-2c. Inside the single frame 2 of the valve block 21 are formed rooms and channels for four hydraulic valves of the invention, in order to minimize the outer dimensions of the valve block.

FIG. 4B shows exploded view of the valve block 21 showing the internal key parts of the separate hydraulic valves of the invention. The hydraulic valves located inside the valve block 21 all have the same structural parts as discussed in relation to the embodiments of FIGS. 1 and 3, for example. In this embodiment, the coils 3 of the solenoid actuators are located around the spaces for anchors 4 within frame layer 2b, instead of being located in frame layer 2a as in the previously presented embodiments.

FIG. 5 shows schematically an embodiment of a digital valve system 20 comprising a plurality of hydraulic valves of the invention and with four metering edges. The valve system 20 is formed of eight pieces of valve blocks 21, each of the valve blocks comprising four hydraulic valves, such as shown in FIGS. 1 and 3 for example. The valve system 20 thus comprises 32 hydraulic valves of the invention. This valve system embodiment has preferably height of about 13 cm, which emphasizes the compactness of the hydraulic valves of the invention.

The specific exemplifying embodiments of the invention shown in figures and discussed above should not be construed as limiting. A person skilled in the art can amend and modify the embodiments described in many evident ways within the scope of the attached claims. Thus, the invention is not limited merely to the embodiments described above.

1. A hydraulic valve which comprises:
an on/off seat-type main valve with two ports comprising a displaceable poppet for opening and closing a main flow channel,
an on/off seat-type pilot valve with three ports, which comprises
a magnetomotive force producing coil,
a magnetic circuit, and
an anchor movable with the magnetomotive force produced by the coil,
and a frame with required channels and spaces for the displaceable poppet of the main valve and for the anchor of the pilot valve, wherein closing of a high-pressure inlet channel of the pilot valve allows displacement of the displaceable poppet of the main valve for opening the main flow channel of the main valve, and wherein opening of the high-pressure inlet channel of the pilot valve forces the displaceable poppet of the main valve to close the main channel of the main valve,
wherein the anchor of the pilot valve comprises a frame with a first sealing element for closing a low-pressure outlet channel of the pilot valve and with a second sealing element for securing the closing of the high-pressure inlet channel of the pilot valve, and wherein a sealing surface of the second sealing element is movable in relation to the frame of the anchor of the pilot valve.

2. The hydraulic valve according to claim 1, wherein the sealing surface of the second sealing element of the anchor of the pilot valve extends at least partially outwards from the frame of the anchor.

3. The hydraulic valve according to claim 1, wherein the sealing surface of the second sealing element is supported with a spring force in relation to the frame of the anchor of the pilot valve.

4. The hydraulic valve according to claim 1, wherein the frame is at least partially manufactured with an additive manufacturing method, preferably by laminated object manufacturing or by selective laser melting.

5. The hydraulic valve according to claim 1, wherein the valve is a miniature hydraulic valve, having volume under 10 cm³ and a flow capacity of over 1 I/min with a pressure difference of 5 bar over the main valve.

6. The hydraulic valve according to claim 1, wherein the frame is formed from two or three separate material layers connected together to form one frame entity.

7. The hydraulic valve according to claim 6, wherein the one frame entity comprises required spaces and channels for a plurality of hydraulic valves.

8. The hydraulic valve according to claim 1, wherein the displaceable poppet of the main valve blocks the flow in the main flow channel in both flow directions.

9. A valve system comprising a plurality of hydraulic valves according to claim 1.
